(19) United States
(12) Patent Application Publication
(10) Pub. No.: US 2026/0239126 A1
(43) Pub. Date: Aug. 13, 2026

(54) MOBILITY EXECUTION IN UNCREWED AERIAL VEHICLES USING CONDITION TRIGGERED EARLY SYNCHRONIZATION

(71) Applicant: InterDigital Patent Holdings, Inc., Wilmington, DE (US)

(72) Inventors: Dylan Watts, Montreal (CA); Brian Martin, Farnham (GB); Paul Marinier, Brossard (CA); Oumer Teyeb, Montreal (CA); Martino M. Freda, Laval (CA); Erdem Bala, East Meadow, NY (US)

(73) Assignee: InterDigital Patent Holdings, Inc., Wilmington, DE (US)

(21) Appl. No.: 19/156,562

(22) PCT Filed: Feb. 13, 2024
(86) PCT No.: PCT/US2024/015615

§ 371 Date: Aug. 14, 2025

Related U.S. Application Data
(60) Provisional application No. 63/445,603, filed on Feb. 14, 2023.

(51) Int. Cl. H04W 36/00; H04W 36/08

(52) U.S. Cl. CPC H04W 36/0072; H04W 36/08

(57) ABSTRACT

Systems, methods, and instrumentalities are disclosed for mobility execution in uncrewed aerial vehicles using condition triggered early synchronization. A wireless transmit/receive unit (WTRU) may receive configuration information including one or more trigger conditions for performing early synchronization with a candidate target cell. The WTRU may determine that the one or more trigger conditions for performing early synchronization with the candidate target cell are satisfied. The WTRU may, based on the determination that the one or more trigger conditions for performing early synchronization with the candidate target cell are satisfied, perform early synchronization with the candidate target cell. The WTRU may transmit a synchronization report.

### CROSS REFERENCE TO RELATED APPLICATIONS

This application claims the benefit of U.S. Provisional Application No. 63/445,603, filed Feb. 14, 2023, the contents of which is incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are disclosed for mobility execution in uncrewed aerial vehicles using condition triggered early synchronization. A wireless transmit/receive unit (WTRU) may receive configuration information including one or more trigger conditions for performing early synchronization with a candidate target cell. The WTRU may determine that the one or more trigger conditions for performing early synchronization with the candidate target cell are satisfied. The WTRU may, based on the determination that the one or more trigger conditions for performing early synchronization with the candidate target cell are satisfied, perform early synchronization with the candidate target cell. The WTRU may transmit a synchronization report.

The one or more trigger conditions may include one or more of a validity period, a geographic area, a last waypoint reached by the WTRU, an interval of time, an interval of distance travelled from a reference point, a height threshold associated with the WTRU, a velocity threshold associated with the WTRU, or a measurement threshold.

A first condition of the one or more trigger conditions may depend on a second condition of the one or more trigger conditions. The WTRU may receive, in a radio resource control (RRC) message or a medium access control (MAC) control element (CE), an indication of a set of parameters associated with the one or more trigger conditions.

The WTRU may detect a synchronization signal block (SSB) from the candidate target cell, determine reception timing associated with the candidate target cell, or determine transmission timing associated with the candidate target cell. The WTRU may synchronize with the candidate target cell before receiving a cell switch command. The WTRU may perform a first early synchronization with the candidate target cell at a first time and perform a second early synchronization with the candidate target cell at a second time. The candidate target cell may include an L1/L2 triggered mobility (LTM) candidate target cell.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of L1/L2 triggered mobility (LTM) using carrier aggregation (CA).

FIG. 3 illustrates an example of LTM.

FIG. 4 illustrates an example of a signaling flow for a flight path report for an uncrewed aerial vehicles (UAV).

FIG. 5 illustrates an example of initial flight path reporting.

FIG. 6 illustrates an example of early synchronization with one or more candidate or target cells based on satisfaction of a conditional trigger for update indication.

### DETAILED DESCRIPTION

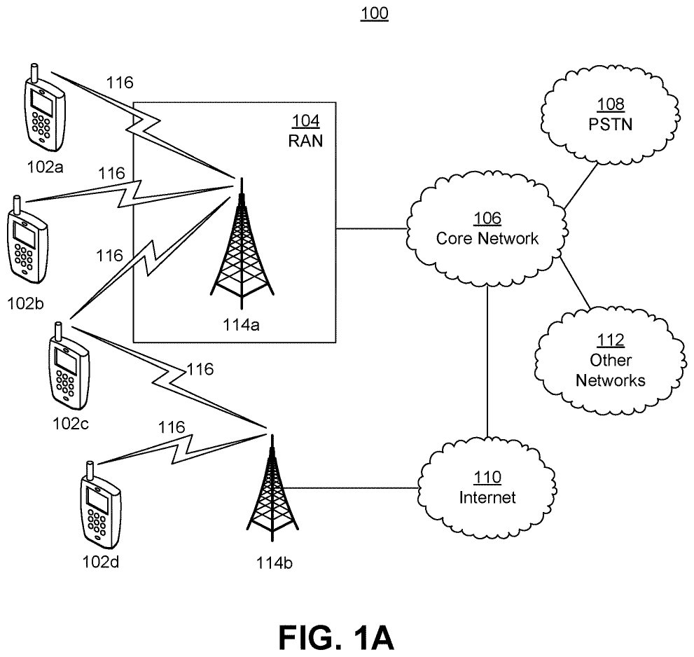

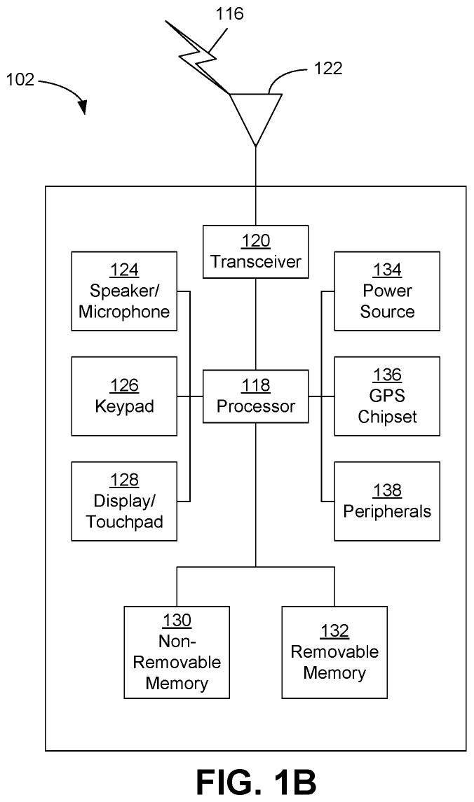

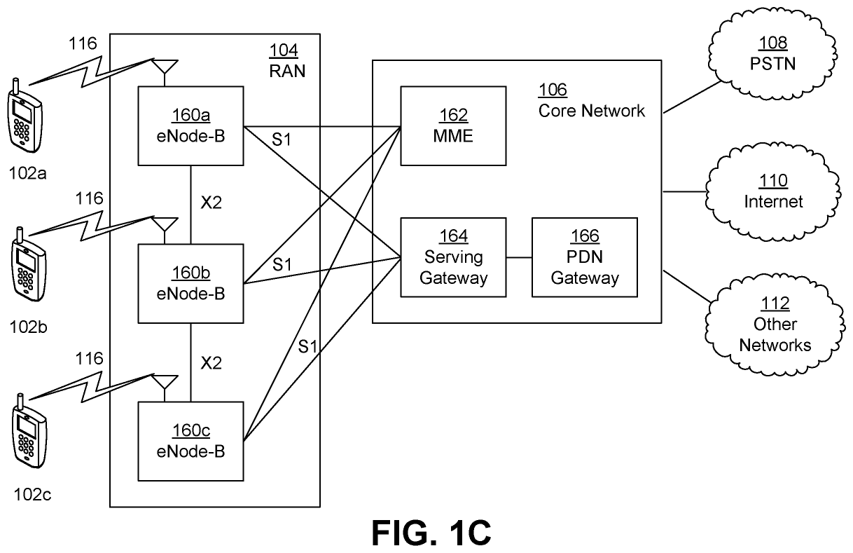

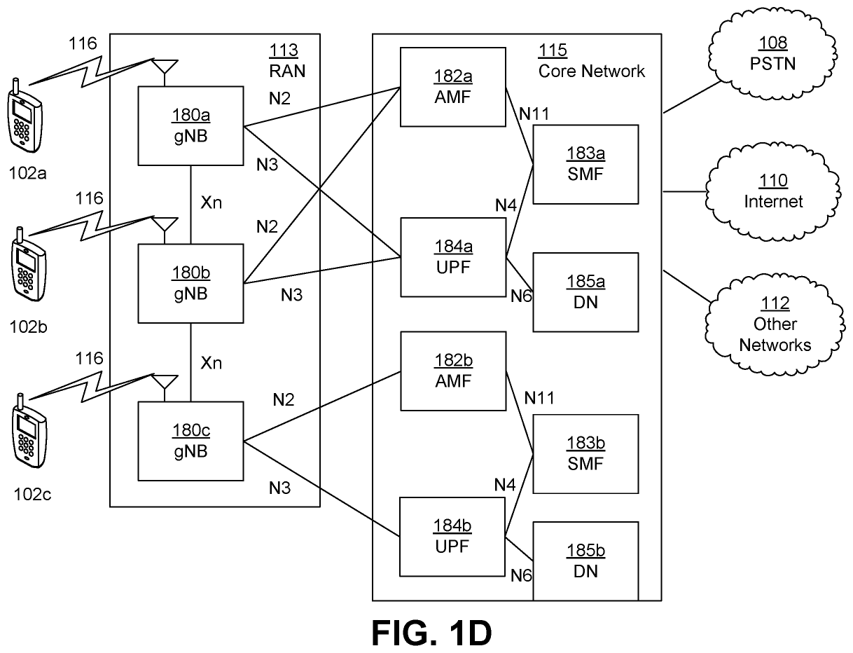

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUS 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Inter-cell L1/2 triggered mobility (LTM) may be implemented. Inter-cell beam management may be used to manage beams in carrier aggregation (CA), with or without cell change/add support. LTM may be used for mobility latency reduction.

LTM inter-cell beam management may address intra-DU and intra-frequency scenarios. In some examples, the serving cell may remain unchanged (e.g., there is no possibility to change the serving cell using L1/2 based mobility). In FR2 deployments, CA may be used to exploit available bandwidth, e.g., to aggregate multiple CCs in one band. The CCs may be transmitted with the same analog beam pair (e.g., gNB beam and WTRU beam). A WTRU may be configured with TCI states (e.g., 64) for reception of a physical downlink control channel (PDCCH) and a physical downlink shared channel (PDSCH). A (e.g., each) TCI state may include a reference signal (RS) or SSB that the WTRU refers to for setting its beam.

The SSB may be associated with a non-serving PCI. Medium access control (MAC) signaling (e.g., a TCI state indication for a WTRU-specific PDCCH MAC CE) may activate the TCI state for a control resource set (CORESET)/PDCCH. Reception of PDCCH from a non-serving cell may be supported by a MAC control element (CE) indicating a TCI state associated with a non-serving PCI. MAC signaling (e.g., TCI States Activation/Deactivation for a WTRU-specific PDSCH) may activate a subset of (e.g., up to 8) TCI states for PDSCH reception. DCI may indicate which of the (e.g., 8) TCI states. A unified TCI state may be supported with a different updating mechanism (e.g., DCI-based), for example, without multi-TRP. A unified TCI state with multi-TRP may be supported.

LTM may improve handover latency. A WTRU may (e.g., first) send a measurement report using RRC signaling with a conventional L3 handover or a conditional handover. The network, for example, in response to the measurement report, may provide a further measurement configuration and/or a conditional handover configuration. In a handover scenario, the network may provide a configuration for a target cell, e.g., after the WTRU reports using RRC signaling that the cell meets a configured radio quality criteria. With conditional handover the network may provide (e.g., in advance) a target cell configuration and/or a measurement criteria that may determine when the WTRU should trigger the CHO configuration (e.g., to reduce the handover failure rate due to the delay in sending a measurement report then receiving an RRC reconfiguration). These L3 methods may suffer from delay due to the sending of measurement reports and receiving of target configurations, e.g., particularly in case of the conventional (non-conditional) handover.

LTM may allow a fast application of configurations for candidate cells, including dynamically switching between SCells and switching of the PCell (e.g., switch the roles between SCell and PCell) without performing RRC signaling. The inter-CU case may not involve relocation of the PDCP anchor. An RRC based approach may support inter-CU handover.

Currently active SCell(s) may be released before the WTRU moves to complete the handover to a target cell in the coverage area of a new site. Currently active SCell(s) may be added back after successful handover, which may lead to throughput degradation during handover. L1/2 may enable CA operation to be enabled instantaneously upon serving cell change.

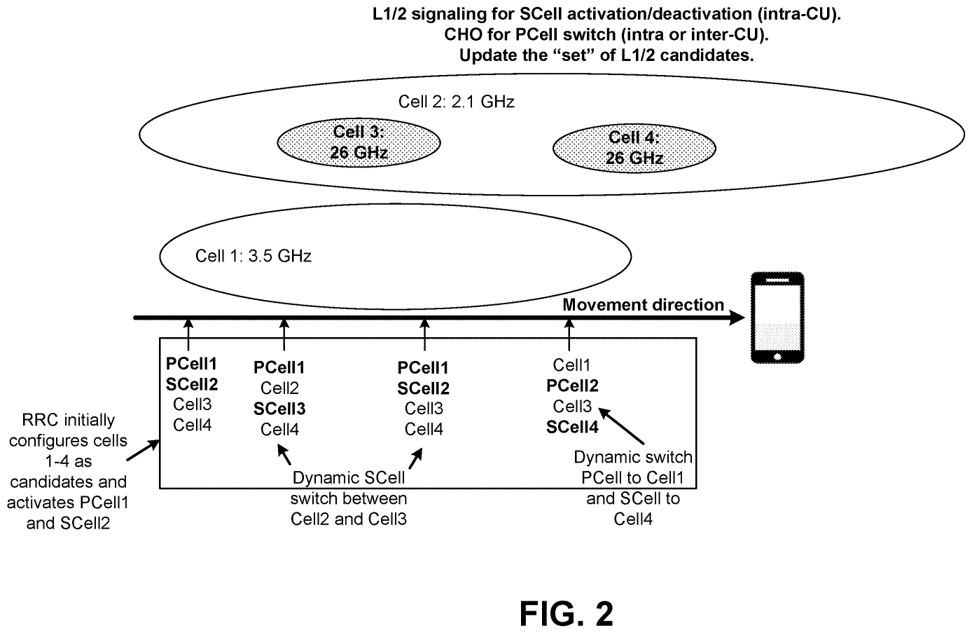

FIG. 2 shows an example of LTM operation. The candidate cell group may be configured using information received via an RRC message. A dynamic switch of a PCell and//or an SCell may be achieved using L1/2 signaling. FIG. 2 illustrates an example of LTM using carrier aggregation (CA).

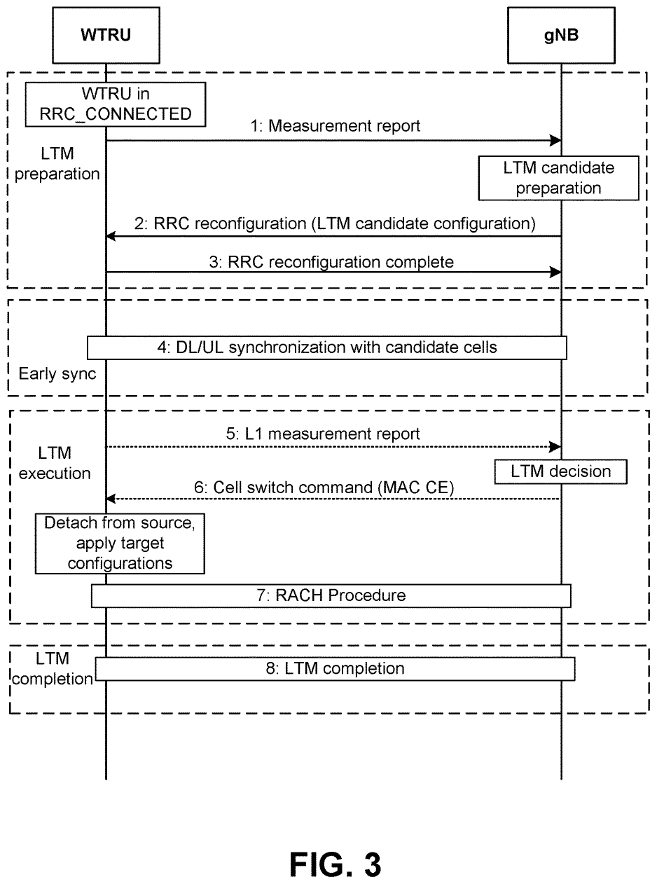

FIG. 3 illustrates an example of an LTM procedure. As shown by example in FIG. 3, at 1, the WTRU may send a MeasurementReport message to the gNB. The gNB may decide to use LTM. The gNB may initiate LTM candidate preparation.
At 2, the gNB may transmit an RRCReconfiguration message to the WTRU, e.g., including the configuration of one or multiple LTM candidate target cells.
At 3, the WTRU may store the configuration of LTM candidate target cell(s). The WTRU may transmit an RRCReconfiguration Complete message to the gNB.
At 4, the WTRU may perform DL synchronization and/or TA acquisition with candidate target cell(s), e.g., before receiving the LTM cell switch command. DL synchronization for candidate cell(s) before cell switch command may be supported, e.g., at least based on SSB (e.g., reception of an SSB). TA acquisition of candidate cell(s) before a LTM cell switch command may be supported, e.g., at least based on PDCCH ordered RACH. The PDCCH order may be triggered (e.g., only) by the source cell.
At 5, the WTRU may perform L1 measurements on the configured LTM candidate target cell(s). The WTRU may transmit lower-layer measurement reports to the gNB. The lower-layer measurement reports may be carried on L1 or MAC.
At 6, the gNB may decide to execute the LTM cell switch to a target cell. The gNB may transmit a MAC CE triggering LTM cell switch, for example, by including the candidate configuration index of the target cell. The WTRU may switch to the configuration of the LTM candidate target cell.
At 7, the WTRU may perform a random access procedure towards the target cell, e.g., if TA is not available.
At 8, the WTRU may indicate (e.g., successful) completion of the LTM cell switch towards the target cell.

An uplink signal or message after the WTRU has switched to the target cell may be used to indicate successful completion of the LTM cell switch.

Uncrewed aerial vehicles (UAV) (e.g., travelling at a height of up to 300 m) may be supported in LTE. Use cases may include drone operation, personal entertainment for flight experience, and cargo delivery. Applications may support the capability for remote control and data transmissions, e.g., including UL and DL interference and mobility.

Measurement reports may be based on configured height threshold. Aerial WTRUs may support height-triggered measurement reporting, e.g., based on WTRU-capability. Height-based events may be defined. For example, Event H1 may occur when aerial WTRU height becomes higher than an absolute threshold. Event H2 may occur when aerial WTRU height becomes lower than an absolute threshold.

Height thresholds may be configured in Meas Config via heightThreshRef. Height thresholds may support values ranging from −420 m to 8880 m, e.g., in increments of 300 m. A WTRU may be configured in ReportConfigEUTRA with offsets h1-ThresholdOffset and h2-ThresholdOffset. A WTRU may be configured with hysteresis parameters h1-Hysteresis and h2-Hysteresis, e.g., to be respectively applied during event evaluation.

WTRU height, location, and/or speed may be reported. A WTRU may be configured to include additional information (e.g., the WTRU height, location, and horizontal/vertical velocity) within a measurement report. Location reporting may be supported via the LocationInfo information element (IE), which may be used to transfer detailed location information available at the WTRU to correlate measurements and WTRU position information. Available information may include WTRU location information (e.g., via locationCoordinates) and/or WTRU bearing and horizontal speed (e.g., via horizontalVelocity).

An LTE UAV feature may involve reporting vertical information via verticalVelocityInfo. VerticalVelocityInfo may include the choice between parameters verticalVelocity, which may include WTRU bearing, horizontal/vertical speed, and/or vertical direction, and verticalVelocityAndUncertainty, which may include information within verticalVelocity and/or uncertainty of horizontal and vertical speed.

Flight path reporting may be supported (e.g., in LTE) for aerial WTRUs based on WTRU capability. Flight path information may include a number of waypoints, which may be 3D locations. A WTRU may indicate if flight path information is available, for example, via RRCConnectionReconfiguration Complete, RRCConnectionReestablishmentComplete, RRCConnectionResumeComplete, and/or RRCConnection SetupComplete messages. Flight path information may allow the network to know immediately after connection whether flight path information is available, enabling subsequent flight path report configuration and request.

An evolved universal mobile telecommunications system terrestrial radio access network (E-UTRAN) may be used to request that a WTRU report flight path information, e.g., via flightPathInfoReq in the UEInformationRequest message. Upon request to report WTRU flight path information, the WTRU may include flightPathInfoReport in the UEInformationResponseMessage including (e.g., all) available waypoints up to the configured maximum. Flight path information may be useful to the network, e.g., for collision avoidance, resource provisioning, and/or WTRU configuration. A configuration of a maximum number of (e.g., up to 20) waypoint locations within a flight path report may be supported (e.g., in LTE). A RAN2 may confirm that a maximum number of (e.g., 20) waypoint locations are sufficient (e.g., for an NR use case).

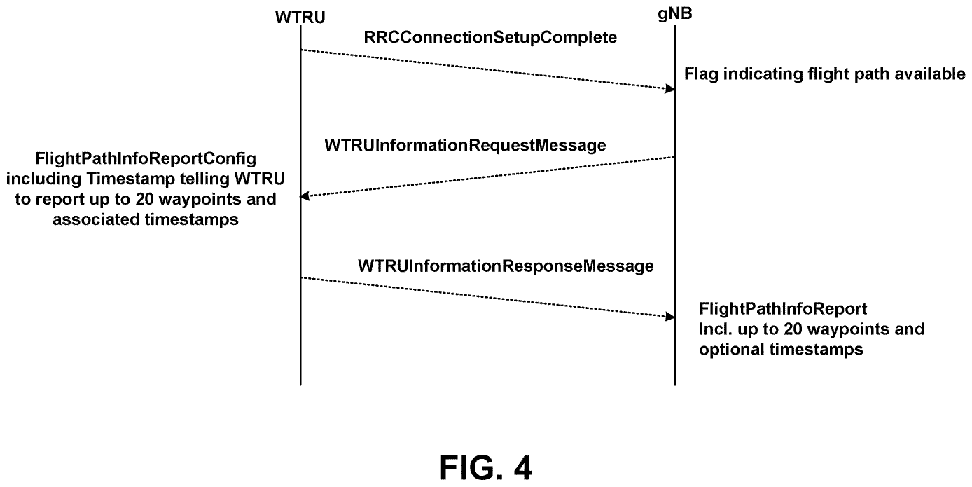

FIG. 4 illustrates an example of a signaling flow for a flight path report for a UAV. A WTRU may be configured to include time stamp information associated with a (e.g., each) waypoint, e.g., via include Time Stamp within FlightPathInforReportConfig. Time stamps may improve the predictability of the WTRU location at a given time, which may aid planning of a WTRU configuration and future resource allocation. Time stamp information may not always be known. Time stamp information may be included in a flight path report, for example, (e.g., only) if such information is available at the WTRU.

Trigger criteria for multiple cells may be simultaneously fulfilled. An aerial WTRU may be configured with a radio resource management (RRM) event (e.g., A3, A4, or A5), which triggers measurement reporting based on per-cell reference signal received power (RSRP) values for a configured number of cells fulfilling the configured event. Once a measurement report is sent, the list of triggered cells may be updated, for example, if subsequent cell(s) fulfil the event. Additional measurement reports may not be sent while the list of triggered cells remains larger than the configured number of cells.

The number of triggered cells required for measurement reporting may be provided, for example, in ReportConfigEUTRA via numberOfTriggeringCells. The number of triggered cells for measurement may range from a minimum (e.g., two (2)) up to a maximum (e.g., eight (8)). Information about the number of triggered cells may be useful, for example, for interference detection and/or to reduce signaling overhead, e.g., by reducing the number of measurement reports.

Aerial WTRUs (UAVs) may be supported in LTE and NR, which may use similar mechanisms for height-based measurement reporting, flight path reporting, and/or simultaneous fulfillment of trigger criteria for multiple cells. Support may be provided for height dependent parameter scaling, user consent for location reporting, flight path update after initial report, and consideration of beams and report on leave condition in numberoftriggeringcells.

In LTM, candidate cells may be preconfigured via RRC. A cell switch may be performed, for example, via L1 signaling and/or based on L1 measurements. Flight path reporting in UAV(s) may inform the network (NW) about where the WTRU is located at a given time, which may enable additional information to be provided (e.g., timing advance (TA) during candidate configuration, provide information about when/where the WTRU should perform and report L1/L2 measurements, and/or aid determinations about which type of RACH procedure to perform. Flight path information may (e.g., also) be leveraged to improve L1/L2 triggered mobility (LTM) early synchronization and execution.

Although examples refer to flight path reporting for UAVs, examples may apply to other devices or circumstances, such as where trajectory or path information is exchanged. For example, examples described herein may be applied to autonomous vehicles, mobile relays/base stations attached to vehicles, etc. In these and other circumstances, “flight path” may be exchanged for an equivalent interpretation (e.g., trajectory, itinerary, etc.).

A WTRU and network may have an accurate understanding of a current UAV flight path (e.g., a current UAV flight path). For example, a WTRU may adhere to the initial flight path report. The WTRU may provide an updated flight path if there has been a change in an initial or previously reported flight path.

Examples described herein may enable a network and WTRU to leverage (e.g., additional) information about the WTRU location (e.g., via flight path reporting), for example, to facilitate timing advance (TA) acquisition, RACH, and LTM execution.

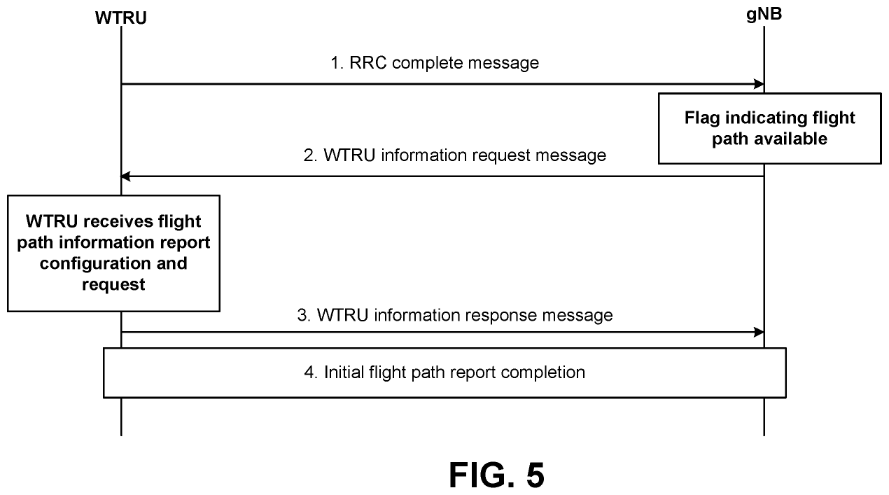

FIG. 5 illustrates an example of initial flight path reporting. Flight path reporting in UAVs may be summarized, for example, by FIG. 5. As shown by example in FIG. 5, at 1, a WTRU, via an RRC message, may indicate if flight path information is available. For example, the RRC message may be RCConnectionReconfigurationComplete, RRCConnectionReestablishmentComplete, RRCConnectionResumeComplete, and/or RRCConnection SetupComplete message.
At 2, E-UTRAN may request that the WTRU report flight path information, e.g., by including the flightPathInfoReq information element (IE) in the UEInformationRequest message. The network may indicate the number of waypoints to be reported (e.g., in the IE) by the WTRU (e.g., up to a maximum of 20). The network may request timestamp information.
At 3, the WTRU may respond to the UEInformationRequest, for example, by including the flightPathInfoReport IE in the UEInformationResponseMessage, including (e.g., all) available waypoints (e.g., up to the configured maximum) and/or timestamp information (e.g., if requested by the network and available at WTRU). A UE information request/response message herein may be a WTRU information response message.

The UAV may have similar flight path reporting content (e.g., waypoints and optional timestamps) and an initial reporting procedure. The UAV may update a previously reported flight path, for example, via an indication in the UE assistance information message. A network may use a UE information request/response procedure (e.g., or another procedure described herein) to retrieve an updated flight path. A UE assistance information message herein may be a WTRU assistance information message. A UE information request/response procedure herein may be a WTRU information request/response procedure.

A WTRU may transmit a flight path update indication (e.g., an indication that the current flight path has changed from the most recent flight path report) and/or an updated flight path report (e.g., a full flight path report including waypoints and/or timestamps or a delta/partial flight path report) via one or more of the following (e.g., signaling examples): UE assistance information; a UE information response message; RRC signaling; a MAC CE; a RACH message (e.g., MSG3, MSG5, MSGA); a configured grant (CG) occasion; an L1 report; and/or a scheduling request (SR).

Triggering conditions (e.g., UAV-specific triggering conditions) may include, for example, one or more of the following: a threshold, a specific value, and/or a range of values. A triggering condition may include a threshold. For example, a triggering condition may be satisfied if the measured value is above, below, or equal to a threshold value. A triggering condition may include a specific value. For example, a condition may be satisfied if the measured value is equal to one or more indicated values. A triggering condition may include a range of values. For example, a condition may be satisfied if the measured value falls within a range. A condition may be satisfied (e.g., alternatively), for example, if the measured value falls outside of an indicated range.

A WTRU may be configured with a height-based condition, which may be used to determine a parameter, a behavior, etc. A height-based condition may be configured by the network (e.g., in RRC) or may be predefined. A height-based condition may be configured by the network. A height-based condition may then be enabled/disabled, for example, by NW signaling (e.g., MAC CE, DCI, a system information block (SIB), RRC, etc.). A height-based condition may be enabled/disabled by another condition (e.g., speed-based condition, waypoint-based condition, etc.).

A height-based condition (e.g., associated with a threshold) may be in the form of a WTRU reaching at least or at most a certain height. For example, a height-based condition may indicate one or more of the following: a WTRU's height may be above a configured threshold; a WTRU's height may be below a configured threshold; and/or a WTRU's height may be between (e.g., two configured) thresholds.

A height-based condition may be in the form of a change in the WTRU's height. For example, a height-based condition may indicate one or more of the following: a WTRU's height changes by an amount greater than a threshold (e.g., within a configured time period/duration); a WTRU's height increased by an amount greater than a threshold (e.g., within a configured time period/duration); a WTRU's height decreases by an amount greater than a threshold (e.g., within a configured time period/duration); a change of the WTRU's height has increased by an amount greater than a threshold (e.g., within a configured time period/duration); and/or a change of the WTRU's height has decreased by an amount greater than a threshold (e.g., within a configured time period/duration).

A height-based condition may be in the form of a time the WTRU spends at a certain height. For example, a height-based condition may indicate one or more of the following: a WTRU's height stays at the same value for at least a configured period of time; a WTRU's height stays within a configured range at least for a configured period of time; a WTRU's height changes by less than a configured amount over a configured period of time; and/or a WTRU has spent the most amount of time (e.g., within a configured period of time) at a certain height.

A WTRU may be configured with a waypoint-based condition (e.g., associated with a threshold), which may be used to determine a parameter, a behavior, etc. A waypoint-based condition may be configured by the network (e.g., in RRC), or may be predefined. A waypoint-based condition may be configured by the network. A waypoint-based condition may be enabled/disabled, for example, by NW signaling (e.g., MAC CE, downlink control information (DCI), system information broadcast (SIB), radio resource control (RRC) signaling, etc.). A waypoint-based condition may be enabled/disabled by another condition (e.g., speed-based condition, height-based condition, etc.).

A waypoint-based condition may be in the form of a WTRU reaching a waypoint (e.g., a given coordinate) and/or being in proximity of a waypoint that was earlier reported in the WTRU's flight path. The condition may be configured for one or more specific waypoints or may be generic for a number of waypoints. For example, a waypoint-based condition may indicate one or more of the following: a WTRU is located at a certain waypoint; and/or a WTRU is within a certain configured distance from a waypoint.

A waypoint-based condition (e.g., associated with a threshold) may be in the form of a time to reach a waypoint or time spent at a waypoint. For example, a waypoint-based condition may indicate one or more of the following: a WTRU may be within a configured distance from a waypoint in less than a configured threshold time; a WTRU may spend at least a configured period of time within a configured distance from a certain waypoint; a WTRU may not be within a configured distance from a waypoint for more than a configured threshold time; and/or A WTRU may spend less than a configured period of time within a configured distance from a certain waypoint.

A waypoint-based condition may be in the form of a change in a reported waypoint. For example, a waypoint-based condition may indicate one or more of the following: a waypoint changes by at least a configured distance; a timestamp associated with a waypoint changes by at least a configured time; and/or a WTRU skips a waypoint (e.g., arrives at a second waypoint that it was expected to arrive at after a first waypoint, before arriving at the first waypoint, etc.).

A WTRU may be configured with a speed-based condition, which may be used to determine a parameter, a behavior, etc. A speed-based condition may be configured by the network (e.g., in RRC), or may be predefined. A speed-based condition may be configured by the network. A speed-based condition may be enabled/disabled by NW signaling (e.g., MAC CE, DCI, SIB, RRC signaling, etc.). A speed-based condition may be enabled/disabled by another condition (e.g., height-based condition, waypoint-based condition, etc.).

A speed-based condition may be in the form of the WTRU reaching at least or at most a certain speed. For example, a speed-based condition may indicate one or more of the following: a WTRU's speed is above a configured threshold; a WTRU's speed is below a configured threshold; and/or a WTRU's speed is between two configured thresholds.

A speed-based condition may be in the form of a change in the WTRU's speed (e.g., acceleration/deceleration). For example, a speed-based condition may indicate one or more of the following: a WTRU's speed changes by an amount greater than a threshold (e.g., within a time period); a WTRU's speed increased by an amount greater than a threshold (e.g., within a time period); and/or a WTRU's speed decreases by an amount greater than a threshold (e.g., within a timer period).

A speed-based condition may be in the form of a time the WTRU spends at a certain speed. For example, a speed-based condition may indicate one or more of the following: a WTRU's speed stays at the same value for at least a configured period of time; a WTRU's speed stays within a configured range at least for a configured period of time; and/or a WTRU's speed changes by more/less than a configured amount over a configured period of time.

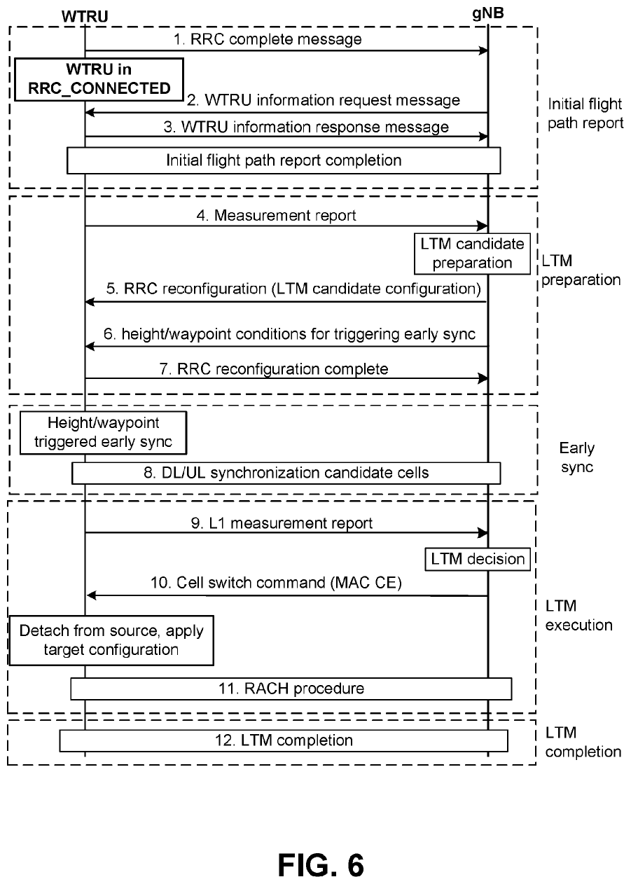

A TA list may be provided at the time of candidate configuration. A WTRU may be provided with one or more candidate TA values associated with, for example, different points along a UAV flight path. The WTRU may determine whether one or more of the preconfigured candidate TA values are suitable for use during LTM execution, for example, based on one or more conditions. The WTRU may use the determination for a subsequent RACH procedure to the target cell. In an example, a WTRU may perform one or more of the following shown in FIG. 6.

FIG. 6 illustrates an example of early synchronization with one or more candidate or target cells based on satisfaction of a conditional trigger for update indication.

A device (e.g., a wireless transmit/receive unit (WTRU) may (e.g., be configured to) perform one or more of the following actions. For example, a WTRU may send an RRC Complete message, e.g., including an indication that flight path information is available. A gNB may transmit (e.g., and the WTRU may receive) a UE information request, e.g., including a configuration for flight path reporting and/or a flight path information request. The WTRU may transmit the UE information response message, e.g., including initial flight path information, which may include waypoints and/or timestamps information (e.g., if configured and available at the WTRU).

The WTRU may send a MeasurementReport message to the gNB. The gNB may decide to use LTM. The gNB may initiate LTM candidate preparation. The gNB may transmit (e.g., and the WTRU may receive) an RRCReconfiguration message, e.g., including the configuration of one or multiple LTM candidate target cells. The WTRU may be provided (e.g., the WTRU may receive) with configuration information. The configuration information may include conditions/events (e.g., trigger condition(s)) to trigger performing early synchronization with candidate target cells e.g., based on waypoint arrival or height. The WTRU may store the configuration of LTM candidate target cell(s). The WTRU may transmit an RRCReconfigurationComplete message to the gNB.

The WTRU may determine that a condition/event (e.g., a trigger condition) is satisfied/triggered (e.g., upon increase or decrease in height, upon arrival at a waypoint). The WTRU may (e.g., based on the condition/event being satisfied/triggered) perform downlink (DL) synchronization (e.g., early synchronization) and/or timing advance (TA) acquisition with candidate target cell(s), e.g., before receiving the LTM cell switch command. The WTRU may perform L1 measurements on the configured LTM candidate target cell(s). The WTRU may perform a first early synchronization with the candidate target cell at a first time and perform a second early synchronization with the candidate target cell at a second time. The WTRU may transmit lower-layer measurement reports to the gNB. The gNB may decide to execute an LTM cell switch to a target cell.

The gNB may transmit (e.g., and the WTRU may receive) a medium access control (MAC) control element (CE) triggering the LTM cell switch, e.g., by including the candidate configuration index of the target cell. The WTRU may switch to the configuration of the LTM candidate target cell. The WTRU may transmit a synchronization report. The WTRU may perform a random access procedure towards the target cell, e.g., if TA is not available. The WTRU may indicate (e.g., successful) completion of the LTM cell switch towards the target cell.

A configuration and signaling may be provided for early synchronization. A WTRU may determine a set of conditions for performing early synchronization to candidate cells. The set of conditions may include, for example, one or more of the following, which may be applicable to at least one candidate cell: a validity period (e.g., early synchronization to a cell may be performed again after a validity period has elapsed); a geographic area (e.g., early synchronization to a cell may be performed if (or only if) the WTRU is within the geographic area); the last waypoint reached by the WTRU (e.g., early synchronization to a cell may be performed if (or only if) the last waypoint of the flight path is a certain waypoint); an interval of time, which may be defined by start time and end time (e.g., early synchronization to a cell may be performed if (or only if) the current time is within the interval of time); an interval of travelled distance from a reference point, such as a waypoint (e.g., early synchronization to a cell may be performed if (or only if) the distance travelled since the reference point is within the interval); a height threshold (e.g., early synchronization to a cell may be performed if (or only if) the WTRU height is above, or below, the height threshold); a velocity threshold (e.g., early synchronization to a cell may be performed if (or only if) the WTRU velocity is below the threshold); and/or a measurement threshold, such as RSRP or RSRQ (e.g., early synchronization to a cell may be performed if (or only if) the WTRU measurement is above the threshold).

One or more conditions and associated thresholds (e.g., as described herein) may depend on another condition. For example, a validity time may be a function of the velocity and/or height of the WTRU. The validity time may be a configured or (pre)defined constant divided by the velocity of the WTRU. In some examples, the validity time may be a first value if the WTRU height is below a threshold, and a second value if the WTRU height is above a threshold.

In some examples, a measurement threshold may be a function of the height. For example, a WTRU may use a first RSRP threshold if the height is above a height threshold, and a second RSRP threshold if the height is below a height threshold.

In some examples, the interval of time, geographic area, interval of distance travelled, and/or the last waypoint may be applicable (e.g., only) if the WTRU height is above a threshold.

In some examples, the set of cells and applicable conditions may depend (e.g. or may be updated) on the last waypoint reached by the WTRU.

A WTRU may receive one or more conditions (e.g., and associated parameters) for one or more candidate cells by signaling, such as RRC or MAC CE. For example, a configuration may be included within an RRC reconfiguration message or within a flight path configuration. The signaling may include, for example, at least one set of cells, e.g., and associated conditions (e.g., trigger conditions) and threshold values. A condition (e.g., and the associated set of cells) may be identified by a condition identity. An indication of a set of parameters may be associated with the trigger condition.

A WTRU may transmit signaling to report based on one or more conditions occurring. For example, a WTRU may transmit a MAC CE after reaching a waypoint. The WTRU may (e.g., subsequently) receive RRC or MAC CE signaling updating the configuration for early synchronization.

Triggering may occur for early synchronization. A WTRU may perform early synchronization to a cell (e.g., and perform subsequent action(s), for example, if at least one of the following conditions (e.g., or combinations thereof) occurs: the WTRU has not detected the cell before; the difference between a current time and the last time when the WTRU performed early synchronization to the cell becomes higher than a validity period applicable to the cell; the cell is included within a set of cells configured for early synchronization; the WTRU position and/or height is in a geographical zone within which the WTRU is to perform early synchronization to the cell; and/or the WTRU receives signaling (e.g., explicitly) requesting early synchronization to an indicated cell.

The WTRU may (e.g., subsequently) transmit a synchronization report. A WTRU may transmit signaling (e.g., a MAC CE), for example, after having performed early synchronization. The signaling may include at least one of the following information: the identity of the cell; at least one detected SSB index, such as the N strongest detected SSB index and/or with a measurement result above a threshold; at least one measurement result applicable to the SSB index and cell; a frequency where the cell is detected (e.g., or identity of a corresponding measurement object); the time at which early synchronization was performed (e.g., the time may be expressed as the time elapsed at the time of initial transmission of the PUSCH including the MAC CE); and/or an indication of the condition that triggered early synchronization to the cell (e.g., the condition may be identified by a condition identity).

A WTRU may transmit information for at least one cell for which early synchronization was performed. The WTRU may (e.g., also) indicate the identity of a cell for which synchronization was not successful, not performed, or performed before the current time minus the validity time, for at least one cell. The at least one cell may include cells that meet condition(s) for early synchronization (e.g., as described herein).

A WTRU may transmit information, for example, based on at least one of the following occurring: the WTRU successfully completes early synchronization for a cell; the WTRU receives signaling (e.g., from DCI or MAC CE) requesting early synchronization for at least one cell; the WTRU receives signaling (e.g., from DCI or MAC CE) requesting the status of early synchronization for at least one cell; and/or at least one of the conditions (e.g., as described herein) is met.

A WTRU may not have line of sight (LOS) with the gNB or TRP. This may occur, for example, in dense urban environments, or in an area surrounded by other large obstacles, such as mountains. A WTRU provided a timing advance value (e.g., based on WTRU reported location or pre-provisioned based on the WTRU flight path) may not be accurate. For example, the best beam may be a reflection and not based on the LOS calculation.

A WTRU and/or network may (e.g., be able/configured to) detect, for example, whether a TRP or gNB has a line of sight with the WTRU. A detection may be based on, for example, one or more of the following: a timing advance with previous TRPs; location/connection information with other WTRU's located close to the WTRU; positioning information, such as reference signals; measurement reporting; and/or statistics collected by the network.

In some examples, the probability of LOS may decrease significantly based on height. For example, a WTRU flying high above the earth may maintain LOS, e.g., in a dense urban scenario. The WTRU may be configured with a height threshold X. The WTRU may assume that it is in a position that line of sight with a candidate is likely, for example, if the current height of the WTRU is above the threshold.

In some examples, a WTRU may infer whether the WTRU has line of sight based on the number of TRPs/gNBs that are visible at one time. For example, a WTRU that can detect greater than X TRPs/gNBs may determine or assume that the WTRU is in a position that line of sight with a candidate is likely. In some examples, the WTRU may conclude that the WTRU is in a position that line of sight with a candidate is likely, for example, if the WTRU is able to observe multiple (e.g., two or more) TRPs/gNBs with similar RSRP.

A network may determine that sections (e.g., some sections) of a flight path are likely to be non-line of sight, for example, based on the flight path. For example, a network may determine non-LOS based on network coverage statistics (e.g., the WTRU may fly through an area that is subject to likely multipath/non-LOS). The network may indicate to the WTRU one or more (e.g., specific) portions of the flight path where it is likely that the WTRU may be within a non-LOS area.

A WTRU may send an indication to the network, for example, if the WTRU detects that it (e.g., the WTRU) is no longer within line of sight with an LTM candidate (e.g., based on satisfaction of one or more conditions (e.g., as described herein)). A WTRU may disable the ability to use one or more candidate TA values for LTM execution (e.g., as described herein) and/or may trust a TA value provided by the network at time of LTM execution (e.g., as described herein). The WTRU may disable the ability to perform RACH-less or 2-step RACH with a candidate cell (e.g., and may instead revert to 4-step RACH), for example, if connecting to an LTM candidate cell. A WTRU may perform one or more actions (e.g., as described herein), for example, based on an indication from the network that the WTRU is no longer within LOS, or while in an area that the network indicates is no longer within LOS.

A confirmation may indicate that no timing advance is necessary. A timing advance applied by a WTRU may be the same for more than one LTM candidate cell (e.g., if the TRPs are co-located). A network may indicate (e.g., within a candidate TA list, as described herein) that the same TA may be applied to multiple (e.g., two or more) LTM candidates. In some examples (e.g., upon transmission of the WTRU location at the time of LTM execution, as described herein), the network may indicate that the current timing advance is valid for the candidate. The WTRU may (e.g., in accordance with the indication) perform cell synchronization/RACH to the LTM candidate using the same timing advance as with the current serving cell.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU) comprising:
a processor configured to at least:
receive configuration information comprising one or more trigger conditions for performing early synchronization with a candidate target cell;
determine that the one or more trigger conditions for performing early synchronization with the candidate target cell are satisfied;
based on the determination that the one or more trigger conditions for performing early synchronization with the candidate target cell are satisfied, perform early synchronization with the candidate target cell; and
transmit a synchronization report.

2. The WTRU of claim 1, wherein the one or more trigger conditions comprise one or more of a validity period, a geographic area, a last waypoint reached by the WTRU, an interval of time, an interval of distance travelled from a reference point, a height threshold associated with the WTRU, a velocity threshold associated with the WTRU, or a measurement threshold.

3. The WTRU of claim 1, wherein a first condition of the one or more trigger conditions depends on a second condition of the one or more trigger conditions.

4. The WTRU of claim 1, wherein the processor being configured to receive configuration information comprises the processor being configured to receive, in a radio resource control (RRC) message or a medium access control (MAC) control element (CE), an indication of a set of parameters associated with the one or more trigger conditions.

5. The WTRU of claim 1, wherein the processor configured to perform an early synchronization with the candidate target cell comprises the processor being configured to at least:
detect a synchronization signal block (SSB) from the candidate target cell, determine reception timing associated with the candidate target cell, or determine transmission timing associated with the candidate target cell.

6. The WTRU of claim 1, wherein the processor configured to perform an early synchronization with the candidate target cell comprises the processor being configured to at least:
synchronize with the candidate target cell before receiving a cell switch command.

7. The WTRU of claim 1, wherein the processor configured to perform an early synchronization with the candidate target cell comprises the processor being configured to perform a first early synchronization with the candidate target cell at a first time and perform a second early synchronization with the candidate target cell at a second time.

8. The WTRU of claim 1, wherein the candidate target cell comprises an L1/L2 triggered mobility (LTM) candidate target cell.

9. A method for a wireless transmit/receive unit (WTRU), the method comprising at least:
receiving configuration information comprising one or more trigger conditions for performing early synchronization with a candidate target cell;
determining that the one or more trigger conditions for performing early synchronization with the candidate target cell are satisfied;
based on the determination that the one or more trigger conditions for performing early synchronization with the candidate target cell are satisfied, performing early synchronization with the candidate target cell; and
transmitting a synchronization report.

10. The method of claim 9, wherein the one or more trigger conditions comprise one or more of a validity period, a geographic area, a last waypoint reached by the WTRU, an interval of time, an interval of distance travelled from a reference point, a height threshold associated with the WTRU, a velocity threshold associated with the WTRU, or a measurement threshold.

11. The method of claim 9, wherein a first condition of the one or more trigger conditions depends on a second condition of the one or more trigger conditions.

12. The method of claim 9, wherein receiving configuration information comprises receiving, in a radio resource control (RRC) message or a medium access control (MAC) control element (CE), an indication of a set of parameters associated with the one or more trigger conditions.

13. The method of claim 9, wherein performing an early synchronization with the candidate target cell comprises at least:
detecting a synchronization signal block (SSB) from the candidate target cell, determining reception timing associated with the candidate target cell, or determining transmission timing associated with the candidate target cell.

14. The method of claim 9, wherein performing an early synchronization with the candidate target cell comprises at least:
synchronizing with the candidate target cell before receiving a cell switch command.

15. The method of claim 9, wherein performing an early synchronization with the candidate target cell comprises performing a first early synchronization with the candidate target cell at a first time and performing a second early synchronization with the candidate target cell at a second time.

16. The method of claim 9, wherein the candidate target cell comprises an L1/L2 triggered mobility (LTM) candidate target cell.
